(19) United States
(12) Patent Application Publication
(10) Pub. No.: US 2006/0259434 A1
(43) Pub. Date: Nov. 16, 2006

(54) Ringtone distribution system

(76) Inventors: Andrew Vilcauskas JR., Tualatin, OR (US); Byran Hunter, Portland, OR (US)

Correspondence Address: CHERNOFF, VILHAUER, MCCLUNG & STENZEL, 1600 ODS TOWER, 601 SW SECOND AVENUE, PORTLAND, OR, 97204-3157, US

(21) Appl. No.: 11/350,053

(22) Filed: Feb. 7, 2006

Related U.S. Application Data
(60) Provisional application No. 60/651,787, filed on Feb. 9, 2005.

(51) Int. Cl. G06Q 99/00

(52) U.S. Cl. 705/57

(57) ABSTRACT

When a mobile telephone ringtone is purchased the distribution system determines whether the provider of the ringtone has a right to transfer a copy of a corresponding audio file before transferring an instance of the ringtone to the purchaser.

### CROSS-REFERENCE TO RELATED APPLICATIONS

This application claims the benefit of U.S. Provisional App. No. 60/651,787, filed Feb. 9, 2005.

### STATEMENT REGARDING FEDERALLY SPONSORED RESEARCH OR DEVELOPMENT

Not applicable.

### BACKGROUND OF THE INVENTION

The present invention relates to a system for providing ringtones to mobile telephone users.

Mobile telephones or cell phones have evolved from purely functional telephones to personally customizable, mobile audio/video/communication centers that commonly feature video games, Internet access, e-mail, cameras, text messaging, specialized background pictures and replaceable faceplates. One of the most popular ancillary data services available for cell phones are customizable ringtones, the music or other audio output of the phone that notifies the user that a call has been received. Customizable ringtones enable users to personalize their cell phones to their own particular tastes with a ringtone that is a manifestation of the user's lifestyle and sensibilities. However, a custom ringtone also performs a utilitarian function in facilitating distinguishing the user's phone from other phones that might be ringing. In addition, many phones permit a user to assign different ringtones to individual callers or groups of callers facilitating identification of the caller before the user answers the phone.

A ringtone comprises a computer program stored in the phone's memory that controls the output of the phone's speaker system when the phone's receiver picks up an incoming call. While a cell phone may provide only one method for capturing a ringtone, many cell phones offer the user a choice among several methods. Some cell phones include a melody composer, a program that enables the ringtone to be entered directly into the phone's memory using the keypad. To facilitate use of the melody composer, several web sites provide information about the correct key press sequence to cause the speaker to output the desired tones. Some phones permit the user to record a song or a voice message for a ringtone. At least one company has developed a computer program that enables a cell phone user convert a music library stored on a computer in MP3 (MPEG-½ Audio Layer 3), WAV (WAVEform audio), or other data formats into ringtones.

The most common method of obtaining a ringtone, however, is to download a ringtone from one of the many ringtone libraries accessible over the Internet. It is estimated that U.S. consumers will download 30 million ringtones in 2005 which will translate to approximately $404 million in sales revenues for the ringtone suppliers. Libraries of ringtones are available from the web sites of most cell phone providers and from a number of other sources. To download a ringtone, the user typically contacts a web site and searches the library of available ringtones for a ringtone that is personally desirable and compatible the user's phone. Once a compatible ringtone has been selected, the program comprising the ringtone is downloaded from the website and loaded into the phone's memory. The program may be downloaded to a computer connected to the Internet and transferred to the phone via an infrared interface or other wireless or wired data link. The ringtone may also be wirelessly transferred from the provider's library directly to the phone. Typically, this is accomplished by sending a special text message containing the ringtone program to the phone. The ringtone is then typically activated by saving the text message or other program in the phone's memory.

Ringtones are available from many sources and locating a desired ringtone can be time consuming. In addition, while many phones output tones comprising multiple notes and some are capable of outputting music from audio files in MP3 or another format, the music quality of downloaded ringtones is uneven and often inferior to music in the CD or MP3 formats. In addition, ringtones are relatively expensive compared to the cost of music singles and copy protection and digital rights management schemes commonly limit the use of a ringtone to a single phone for a limited period of time. What is desired, therefore, is a system that enables users to conveniently select and obtain high quality ringtones.

### BRIEF DESCRIPTION OF THE DRAWINGS

FIG. 1 is a network based ringtone distribution system.

FIG. 2 is a block diagram of one embodiment of a ringtone distribution system.

FIG. 3 is a block diagram of another embodiment of a ringtone distribution system.

FIG. 4 is a block diagram of another embodiment of a ringtone distribution system.

FIG. 5 is a block diagram of another embodiment of a ringtone distribution system.

FIG. 6 is a block diagram of another embodiment of a ringtone distribution system.

FIG. 7 is a block diagram of monitoring software for use with the ringtone distribution system.

FIG. 8 is a block diagram of exchange limitations for use with the ringtone distribution system.

FIG. 9A is a block diagram of a further embodiment of a ringtone distribution system.

FIG. 9B is a block diagram of a further embodiment of a ringtone distribution system.

FIG. 10 is a block diagram of a further embodiment of a ringtone distribution system.

FIG. 11 is a block diagram of a further embodiment of a ringtone distribution system.

FIG. 12 is a block diagram of a further embodiment of a ringtone distribution system.

FIG. 13 is a block diagram of a further embodiment of a ringtone distribution system.

FIG. 14 is a block diagram of a further embodiment of a ringtone distribution system.

### DETAILED DESCRIPTION OF THE INVENTION

After considering the limitations of the process involved in selecting and obtaining ringtones and the inherent music quality and quality of service limitations, the present inventors came to the realization that a different method of ringtone distribution is desirable. The costs of obtaining ringtones, restrictions on transferring a ringtone to another phone, and limitations on the useful life of a ringtone make cell phone users reluctant to purchase or update ringtones. The present inventors concluded that if ringtones could be used as long as desired, transferred to a new phone, and/or sold to another party, consumers would be more willing to acquire multiple ringtones and update ringtones as their tastes changed. To improve the attractiveness of ringtone acquisition, the new paradigm of ringtone acquisition should be based upon ownership of the music or other content of the ringtone so that the artists or other content creators are properly compensated for their work.

While some cell phones permit the user to record an original song or a voice message for use as a ringtone, users of custom ringtones typically seek to adapt a portion of a commercially available, recorded, musical or other audio composition as the ringtone for their cell phone. By purchasing a compact disk or other medium that includes the desired content, the purchaser can obtain certain ownership rights in a composition or other content included on the medium, including a right to reformat the content for use as a ringtone. The purchaser may sell the compact disk or other medium and transfer the rights in the content obtained with original purchase to the next purchaser of the medium. By acquiring a compact disk or other medium that includes desired music or other content, the cell phone user can obtain ownership rights in the corresponding ringtone, including the right to use the ringtone as long as desired and to move the ringtone to a replacement phone, as long as only one copy of the ringtone is in use. Likewise, the user may then remove the ringtone from the phone and resell the medium, usually at a discount, to a purchaser who will acquire the seller's rights with regard to the content of the medium, including the right to reformat the content for use as a ringtone. However, delivering a compact disk or other medium to the user or a subsequent purchaser, including an Internet based purchaser, typically involves the time and expense associated with the postal service. In a similar way, it is time consuming to travel to a music store to purchase a compact disc, create a ringtone from the content, and then, when use of the ringtone is no longer desired, travel to a used music store to sell the compact disc for typically less than one-half of the original purchase price.

An individual may also acquire rights, in the nature of ownership, to a desired audio composition by purchasing a copy of a data file containing the audio composition from a seller having a license that includes the authority to sell copies of the file. The prospective purchaser typically contacts a website comprising a library of audio files and, in exchange for the purchase price, is permitted to download a copy of the audio file to the purchaser's computer or audio player or cell phone. Since the seller has the right to sell a copy of the audio file, the purchaser has a right to reformat the file a ringtone and the seller may reformat as required before sale or downloading a corresponding ringtone. While there may limitations on the rights of the purchaser, such as a number of copies of the ringtone that the purchaser may make, a number of devices on which the ringtone may be installed, and the life of the ringtone, the purchaser acquires a paid-up license to the audio file and corresponding ringtone that includes any rights that the seller is permitted to transfer.

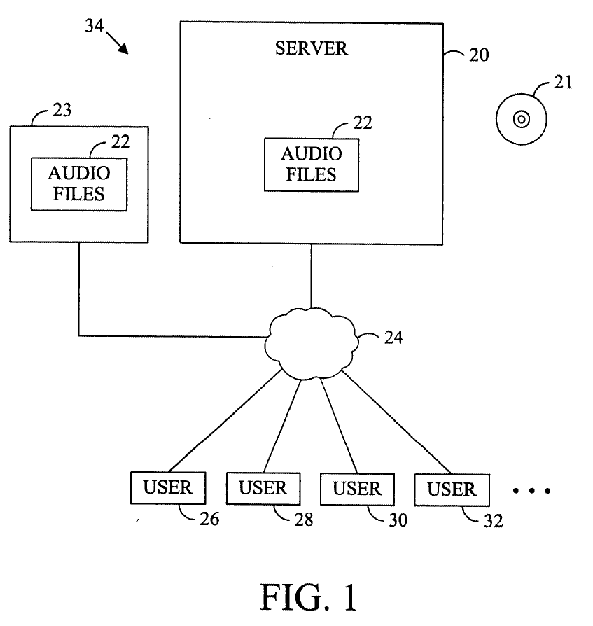

Referring to FIG. 1, in the ringtone distribution system a server 20 stores audio files 22. The audio files 22 are preferably obtained through electronic transfer or from a compact disk, record, tape, or other medium 21 or by sampling an analog audio signal. The audio files 22 may be stored in any convenient format, including by way of examples, the RED BOOK standard format for compact disks, the WAVEform (WAV or WAVE) audio format, Musical Instrument Digital Interface (MIDI) file format, or the MP3 (MPEG- 1/2 Audio Layer 3) format. To conserve the storage resources of the server, the audio files are typically compressed to a size smaller than they would have been without compression. It is to be understood that the audio files 22 may not be physically present on the server 20, but the server may have access by electronic transfer or otherwise to audio files 22 stored on a remote data processing device 23. The server is interconnected to the Internet 24 which is understood to be any type of computer network which permits communication between multiple computing devices, such as other computers, servers, personal digital assistants (PDAs) or cell phones. Multiple users 26, 28, 30, and 32 may be interconnected to the Internet 24 to facilitate communication with the server 20.

The audio files 22 may also include music or other content stored in one or more of the ringtone formats used with mobile telephones or cell phones (phones). A ringtone is a computer program that is stored in the memory of a cell phone and which controls the output of the phone's speaker system to produce a desired series of tones when the phone receives a call. Over time, cell phone manufacturers have adopted a number of data formats for ringtones and, while some cell phones accept only a single ringtone format, some phones are able to utilize more than one format. Ringtones may be monophonic comprising a series of single note tones or polyphonic comprising a series of tones each comprising a plurality of notes. In some cases, phones are capable of outputting ringtones that are tonally comparable to the original recording. Ringtone data formats include, but are not limited too, MIDI, Scalable Polyphony MIDI (SP-MIDI), eXtensible Music Format (XMF), AAC (Advanced Audio Coding), AMR (Adaptive Multi-Rate) and MP3. While the stored audio files 22 may include prerecorded ringtones in one or more formats, an audio file containing a ringtone may be created on-the-fly by reformatting an audio files 22 stored in another format. However, for each of the audio file 22 corresponding to a song or other unit of content stored on the server 20 or created by reformatting a song or other content, a corresponding copy of the compact disk or other medium is owned, or a license to the content is otherwise obtained, by the system provider 34 (e.g., an entity that provides the audio files for the user). The provider 34 has purchased transferable ownership rights to each copy of corresponding song, composition, or other content available on the server 20 that may be downloaded as a ringtone,

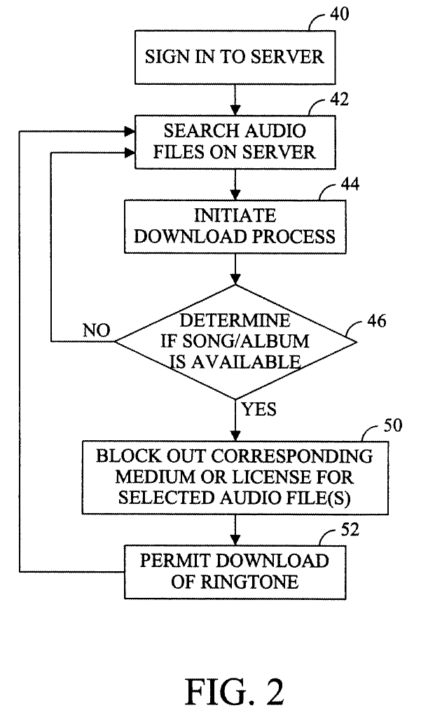

Referring also to FIG. 2, the user may initially sign into the server 20 to listen to audio files 22 at block 40. The user may search the audio files 22 on the server 20 at block 42 by any suitable technique, such as for example, artist, name of album, name of song, name of composer, name of producer, genre, etc. After locating a suitable song or other audio file, the user communicates the selection to the server 20. A ringtone typically corresponds to a portion of a song or other composition and while the user may select a ringtone comprising a preselected portion of the audio file, the server may permit the user to arbitrarily select any portion of the song or file for downloading as a custom ringtone.

Following selection of the ringtone, the user may initiate the downloading process at block 44 for a ringtone corresponding to the desired content contained in an audio file 22. Initially the server 20 determines if a ringtone corresponding to the desired song or content from the respective album or subject to the respective license is currently downloaded or in use by another user at block 46. If a ringtone corresponding to the desired song (content) or another song from the respective medium or subject to the respective license has been downloaded or is being downloaded by the same or another user, then the system determines if a sufficient number of copies or licenses are owned by the provider 34 to permit another download. In this manner, for each ringtone corresponding to a copy of a song, or a song on a particular album or compact disc, or other content, a corresponding copy of the compact disk, a license, or other right to download a ringtone, is verified as being owned by the provider 34. It is to be understood that when reference is made to a particular album, compact disc, digital media, digital rights, tape, license, group of associated songs, group of audio files for which a license to use or ownership has been obtained or otherwise established, the reference applies collectively to the entire group, even if not explicitly stated. At block 46, the song, other content, or album is determined to be available or not available. If the appropriate song, content, or album is determined to be available at block 46, a ringtone corresponding to the song or other content is downloaded to the user and the corresponding copy of the compact disk or license is “locked out” or otherwise made unavailable to other users at block 50, if no further ownership rights are available. In this manner, the owners of any copyrights in the audio content are compensated for their contribution because only one copy of that content, albeit in a different format, which was obtained by the provider 34 is provided to any user at any particular time.

If a ringtone corresponding to a copy of a song or other content on of a corresponding album is not downloaded, not being downloaded by others, or if the service provider 34 otherwise has a license or ownership interest in another copy of (or the only copy of) the content, then the user is permitted to download a ringtone corresponding to the content at block 52. Upon downloading a ringtone and/or selecting a ringtone to be downloaded, the compact disk, medium, or license that includes or otherwise governs the content corresponding to the ringtone is indicated as “unavailable.” In this manner, ringtones are made available to users in a convenient manner where quality may be maintained. The provider 34 may maintain physical control over the media 21 and may or may not provide the physical medium 21 to the user, if desired. Further, the user may or may not elect to receive a copy of the applicable license.

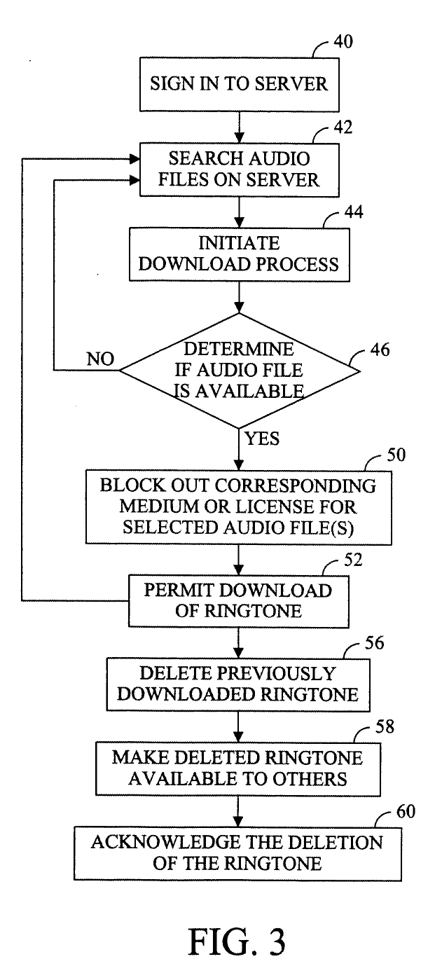

Referring to FIG. 3, (a further embodiment) after the user has completed downloading a ringtone, the user may desire to search for other ringtones corresponding to songs on different albums or content included on other media or subject to different licenses. Prior to downloading a ringtone corresponding to content from a different album or medium or subject to a different license, the user may delete, if desired, the copy of the ringtone(s) previously downloaded from the server 20 at block 56. Upon deleting the previously downloaded ringtone, the corresponding compact disk, other medium, or license that was “locked out” is then made available to other users at block 58. After deleting the previously downloaded ringtone, and preferably acknowledging the deletion of the ringtone at block 60, the user may start downloading another ringtone from a different medium or subject to a different license. In this manner, ringtones may be provided to a user without violation of the copyright owner's interest in the content because only a single copy of a ringtone corresponding to a particular song or album, for which a legitimate ownership interest has been obtained, is downloaded or otherwise transferred, at any particular time, albeit preferably in a ringtone format.

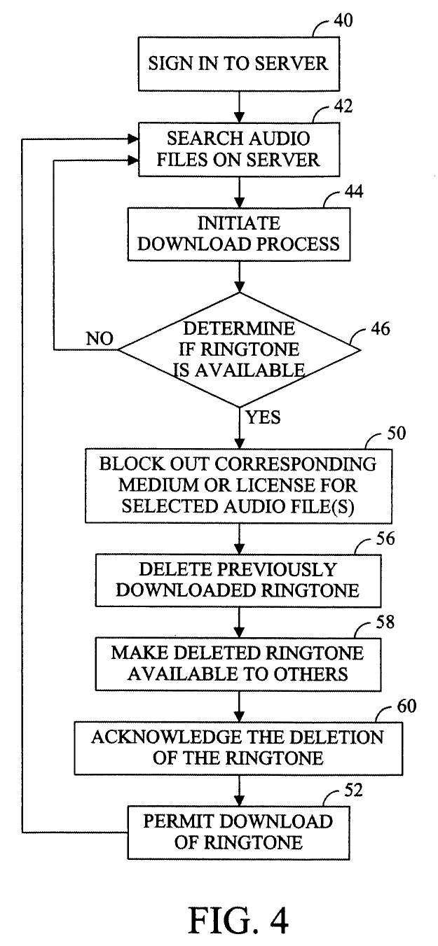

After consideration of the process by which the audio files are made available to the user, the present inventors realized that rearranging the order of the processes may result in a decrease in the number of media or licenses for which ownership rights need to be obtained. Referring again to FIG. 3, if the corresponding medium or license is blocked out at block 50 and a corresponding ringtone is permitted to be downloaded at block 52, there exists the possibility that considerable time may elapse before the user actually acknowledges the deletion of the previously downloaded ringtone at block 56. Referring to FIG. 4, it is preferable that the deletion at block 56, the acknowledgment at block 60 (if provided), and the making available of a ringtone at block 58 are performed prior to permitting downloading of the newly selected ringtones at block 52. In this manner there is a reduced likelihood of multiple audio files from different albums being “locked out” for a significant period of time.

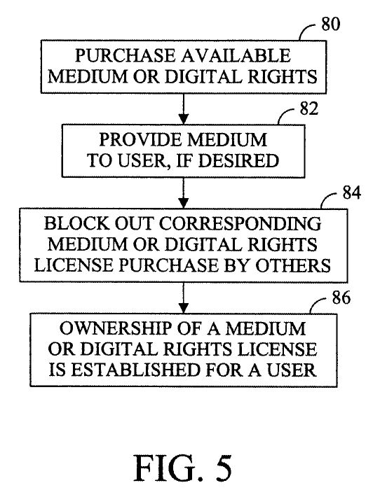

Referring to FIG. 5, the system may include a membership or fee based subscription service. Prior to signing into the server at block 40 (see FIG. 2), the user may purchase a compact disk or other media or rights to content, such as, for example, a paid-up license, at block 80 from the service provider 34 or another source. The purchase price may include for example, the retail price of the compact disk or medium or the purchase price of rights to an audio file 22, and an account setup fee. In this manner, the ownership rights of a particular compact disk (or other media/digital rights) are attributed to a particular user, while the service provider 34 maintains physical control over the compact disk or license on behalf of the user. Since the transaction may be considered a sale or otherwise a purchase, the system may provide the option for providing the compact disk or medium to the user at block 82. In this manner, the compact disk or medium is available to the user, if desired. If the compact disk or other medium is stored by the service provider 34, then the corresponding compact disk or medium is “locked out” or otherwise made unavailable from being purchased by other users at block 84. Accordingly, ownership of a compact disk or medium is established for a user at block 86 by the user's purchase thereof. Alternatively, the rights to the audio content of a file 22 may be purchased or otherwise established in any other manner. For example, a paid-up license to content corresponding to a ringtone may be obtained and communicated to the service provider 34 to establish ownership rights in the content, a compact disk may be inserted into a computer to establish the ownership of the installed compact disk, or an ownership interest a medium may be otherwise established. Preferably, the ownership interest is sufficient to transfer an identical ownership interest to others by a gift, sale, transfer, or otherwise.

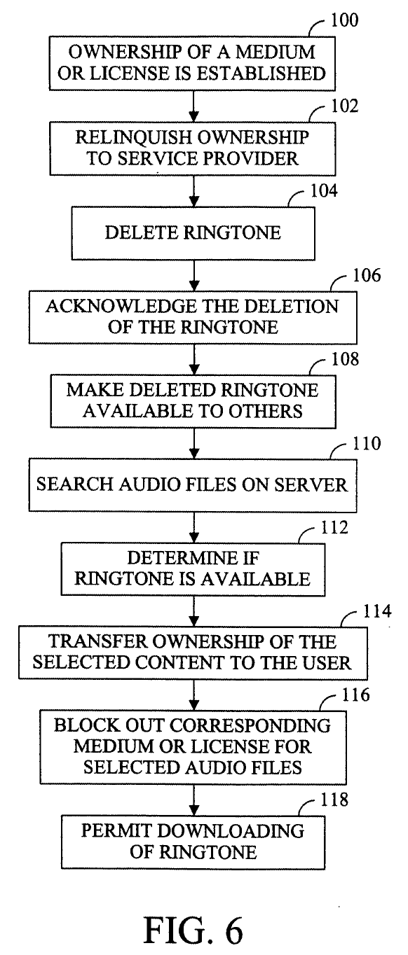

Referring to FIG. 6, ownership of a compact disk or other medium or license for a user is established at block 100 in any manner. The user may relinquish ownership of the medium or license to the service provider 34 at block 102. This relinquishment may be performed, for example, by selling the compact disk or license back to the service provider 102 and crediting the user's account. In the case of a ringtone, and the desire to fully transfer effective ownership to those audio files, if any, the user preferably deletes the ringtone that the user received corresponding to the compact disk or license that the user had an ownership right to at block 104. The user may acknowledge the deletion of the ringtone at block 106. It is to be understood that any other technique may be used to effectuate the “deletion” of a ringtone, such as for example, using technology that results in the ringtone being non-functional after an event such lapse of a period of time, removing the header portion from the program comprising the ringtone, or encoding the ringtone so that it is no longer usable. The service provider 34 may then make the deleted ringtone, acknowledged if desired, available to other users at block 108. The user may search the audio files on the server 110 to locate a desirable ringtone. The system determines if the ringtone is available from the availability of a medium or other rights to the content at block 112. If the ringtone is available at block 112 a transaction between the user and the system is performed at block 114 transferring ownership in the corresponding ringtone. The ownership transfer of the ringtone may be performed by the user, such as for example, using a credit existing in the user's account, paying for the medium, exchanging a previously owned compact disk, other medium, or license established at 100 for the compact disk, medium or license to the content selected at block 112, or otherwise. In essence, the system effectuates a transfer of the ownership of a compact disk, other medium or license from the service provider 102 to the user, or it may effectuate a transfer of the ownership of a compact disk, other medium, or license from one user to another user. This transfer is preferably not in the nature of a rental, a lease, lending, or by any other act or practice in the nature of rental, lease, or lending. In that way an effective transfer of ownership, or otherwise a sale, of rights to the content is accomplished at block 114. The corresponding compact disk, other medium, or license for the selected audio content is blocked out at block 116. With the effective transfer at block 114 and the blocking out of the medium or license at block 116, the downloading of the corresponding ringtone may be effectively performed at block 118, without impinging on any prohibition, under the Copyright Act, 2001, against a transfer that is in the nature of a rental, a lease, lending, or the like.

In the preferred embodiment, the user is permitted to download ringtones corresponding to the content from a single compact disk, album, or otherwise, for which a corresponding compact disk or otherwise is “locked out” from being provided to another user. If the user desires to simultaneously download or otherwise maintain copies of audio files from multiple media or licenses, then the service provider 34 would “lock out” multiple media or licenses, namely, a medium or media or licenses that collectively contain all of the audio files that correspond to ringtones currently selected, downloaded, or being downloaded by the user. In this manner, the artist's rights in the music are protected from unauthorized downloading or other appropriation without proper compensation.

It is to be understood that the user may purchase or otherwise establish ownership for multiple media or licenses, if desired. In that manner, the user does not need to delete all of the downloaded ringtones, but only those ringtones corresponding to the compact disk, other medium, license, or otherwise that includes or otherwise governs the content to which ownership is being transferred back to the service provider 34 or to another user. This permits the user more flexibility in the selection of ringtones without deletion of any ringtones that have been lawfully obtained and which may be retained following a transfer.

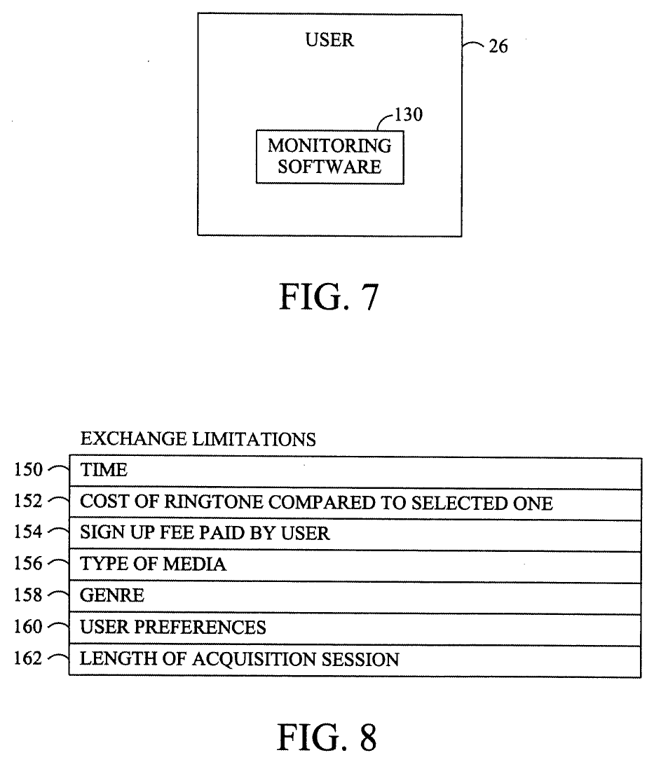

Referring to FIG. 7, the system may include monitoring software 130 installed or otherwise operating on the user's cell phone, or available to the user through a networked connection, to assist in the selection of suitable ringtones. The monitoring software 130 may include an interface that permits searching for and selection of ringtones by artist, genre, lyrics, year, decade, title of album, title of song, or any other suitable search criteria. If desired, the monitoring software 130 may track the downloading of ringtones corresponding to one or more audio files available from the server 20. Thereafter, when the user desires to download additional ringtones corresponding to audio files from other media or licenses, the system may automatically delete a previously downloaded ringtone so that the corresponding compact disk, other medium or license may be made available to other users.

The exchanging of ringtones using the server may be further limited or otherwise modified by other criteria. Referring to FIG. 8, the criteria may include a limited time during which the user is permitted to use the ringtone at block 150. In this manner, the purchase, transfer of the ownership, or otherwise will only be valid for a limited time duration, such as 18 months. This likewise permits the service provider 34 to maintain a smaller collection of compact disks, media, or licenses because the corresponding audio content is not “checked out” to a particular user for an extended period of time. The time limitation may be based upon, the user's voluntary agreement to delete the ringtone after a time duration, the monitoring software 130 deleting the ringtones, a time indication provided with the audio file indicating the time during which the ringtone may be used, the ringtone being rendered inoperable at other times by any suitable technique.

It may be observed that this system of exchanging or otherwise transferring ownership rights to audio files corresponding to compact disks, other media, licenses, or rights in content, results in a system that permits users to utilize to a wide selection of ringtones. In this manner, the system may be free from the necessity to purchase or otherwise obtain licenses from the copyright holders apart from the license that comes with the purchase of the media or the acquisition of the audio file by the service provider.

The criteria may include a comparison between the value of the ringtone currently purchased or otherwise attributed to the user, and the value of the desired ringtone, at block 152. This permits the system provider 34 to avoid situations in which the user purchases a relatively inexpensive ringtone and exchanges that ringtone for a relatively expensive ringtone, thereby depriving the service provider 34 or another user of adequate compensation. Likewise, if the user purchases a relatively expensive ringtone and exchanges that ringtone for a relatively inexpensive ringtone, the user's account may be credited or the user reimbursed in some suitable manner. The relative value of ringtones may be established by comparing the cost of the compact disk or other media containing the respective audio file or comparing the cost of licensing the respective audio files.

The criteria may include limitations based on the sign up fee paid by the user. In general, differing numbers of ringtones may be downloaded, more extensive selections of audio files may be made available to certain users, and greater flexibility may be offered if the user pays a relatively higher fee at block 154. The criteria may include limitations based upon the type of the media at block 156, such as for example, analog tape, 8-track, laser disc, compact disk, album, super audio compact disk, digital audio disc, etc. In this manner, the system may compensate for the expense of purchasing the corresponding license or media, with compact disks tending to be more expensive than tapes and albums being more expensive than singles.

The criteria may include the genre of the music being listened to at block 158. The popularity of music in some genres, such a rock, tends to be transitory in nature so that the album is in high demand for a limited period of time therefore resulting in the service provider 34 purchasing many copies of the corresponding media or license. However, after a limited period of time, the album will tend to be relatively unpopular after which the service provider 34 will have a large collection of corresponding media or license without any corresponding demand. After this occurrence, the service provider 34 may sell the corresponding media or licenses at a considerable loss. In contrast, genres that have a stable demand will not result in such temporary over purchasing of corresponding media or rights and therefore will tend to be less expensive for the service provider 34.

The criteria may include user preferences at block 160 by which the user selects exchange and usage limitations. The user preferences may be used as the basis for determining the fee criteria for the exchanging of ringtones or otherwise.

The criteria may include the length of the ringtone acquisition session; number of ringtones exchanged or downloaded, or otherwise the number of audio files on a particular compact disk(s) or medium at block 162. Similarly, this criteria may permit the service provider 34 to adjust the fee schedule based upon the bandwidth for file transfer that the user will be using to download the ringtone.

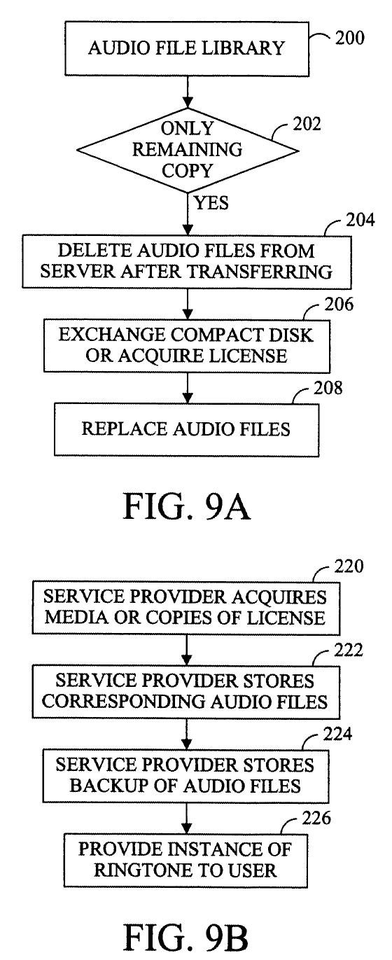

The present inventors determined that there may be copyright ownership considerations relating to storing compressed digital audio files, such as MP3 files, on the server, transferring the ownership of the compact disk or otherwise to the user, permitting downloading of ringtones corresponding to the audio files included on a medium or subject to an applicable license to the user, while still maintaining the audio file on the server after the transfer has occurred without another copy of the medium being owned or licensed by the service provider 34 or other users, and maintaining backups of the audio files. In essence, the service provider 34 may have transferred ownership of the medium or instance of a license and the corresponding ringtone or other audio file but might retain a copy of the audio file on the server. Referring to FIG. 9A, the service provider 34 may store one or more of the compact disks in a compact disk jukebox 200 or other system that makes the physical compact disk or medium available on demand. In the event that the downloading of a ringtone corresponding to an audio file represents the only remaining copy of the corresponding compact disk or medium owned by the service provider 34 (block 202), then the service provider 34 may delete the audio file after transferring the ringtone to the user at block 204. In this manner, only one single copy of the audio file and possibly a backup of that audio file will be maintained corresponding to a single compact disk, other medium or instance of an applicable license. After the user exchanges the ringtone at block 206 the audio files may be “ripped” from the compact disk or other medium at block 208 to the server or possibly retrieved from a backup copy or downloaded from a content provider to replace the audio files previously deleted. In addition, the user could likewise transfer the user's rights to the ringtone back to the server, if desired. However, for each compact disk, medium or license where the service provider 34 has multiple copies of the same disk, medium, or license, the service provider 34 may only need to “rip” one set of audio files, which could result in substantial time and cost savings. Moreover, with the “ripping” of the audio files being performed by the service provider 34 the quality and completeness of the audio files may be maintained.

Referring to FIG. 9B, the service provider 34 acquires ownership rights in an assortment of compact disks and media at block 220. The service provider 34 likewise may store audio files corresponding to the content of the compact disks and media and to audio files in which ownership rights are acquired by license at block 222. Further, the service provider 220 may likewise have internal backups of the audio files at block 224. The user may download the ringtones corresponding to the audio files from the provider 34 at block 226. In the event that an insufficient number of a particular compact disk, medium or license is not “locked out” or otherwise is available to other users, such as the last copy of content of a compact disk is provided to a user at block 226, then the service provider 34 may be considered to be storing a backup copy of the audio files on the server 20 on behalf of the user. In this manner, when user exchanges the particular ringtone the server 20 may use the previously stored backup of the corresponding audio file for another user. Accordingly, the system may permit the last compact disk, medium, or license to be “locked out” while retaining a backup copy of the corresponding audio files on the server 20 to alleviate the need to “rip” another set of audio files from the compact disk or medium or download an additional copy from another source.

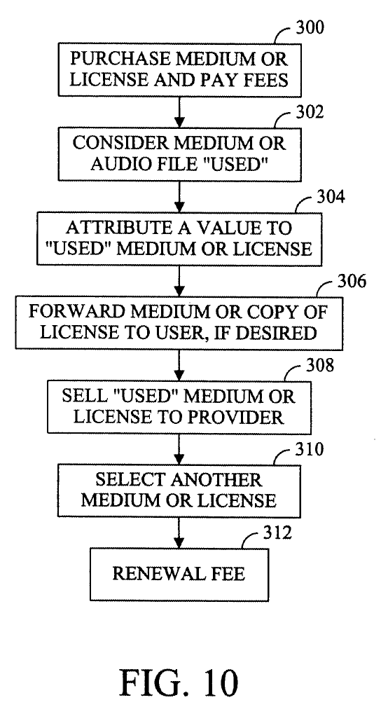

Referring to FIG. 10, the service provider 34 may provide an annual or other periodic subscription model for operating the service business. For example, the user may initially purchase a compact disk, other medium, or license, and pay an account setup fee and/or renewal fee at block 300 and/or other fees. The purchase of the compact disk, medium, or license may be at a retail price or other suitable price. The fee for the compact disk, medium, or license may likewise vary based on the price of the compact disk, medium or license selected. The account setup fee may be for example, a one time fee for creating an account on the system. The renewal fee may be a periodic fee, such as monthly, quarterly, annually, etc., for access to or otherwise using the system. After a period of time, such as an annual time, the system may consider the purchased compact disk, medium, or license as a “used” compact disk, medium or license, even though the actual medium may not have been actually removed from its packaging or otherwise used in the traditional sense at block 302. The compact disk, medium, or license assigned a “used” value may be the disk, medium, or license corresponding to a ringtone currently downloaded by the user; the compact disk, medium or license purchased when setting up the account; or otherwise any suitable medium or right to the audio files. A value may be attributed to the “used” compact disk, medium, or license at block 304. The user may have the option of having the “used” compact disk or medium forwarded to them, with the addition of shipping and handling charges, if desired at block 306. If the user does not desire to have the medium forwarded, such as at the end of a renewal period, then the “used” value of the medium or license may be credited to the user's account by deleting the ringtone and selling the medium or license to the service provider 34 or another user at block 308. The user may then select another compact disk, medium or license for the next period of time, such as an annual time, at block 310. The service provider 34 may charge the user a fee for the renewal, which may include for example, a renewal fee and the price of the new medium or license minus the “value” of the “used” medium or license, at block 312. In this manner, the user has the option of selling the “used” medium or license, if desired. In addition, the user may have the option of crediting the sale of the “used” medium or license toward the purchase of a new medium or license to a ringtone for the next time period. In other words, this effectuates a sale of the license or the compact disk or medium being stored by the service provider 34 and likewise permits the user to purchase another compact disk, medium, or license from the service provider 34 or another user.

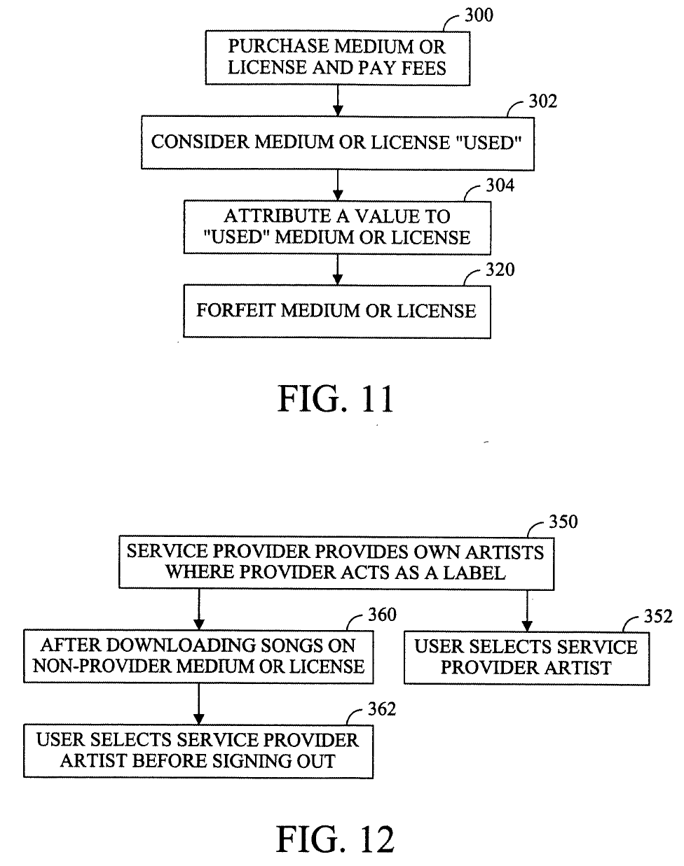

Referring to FIG. 11, another option for termination of the annual subscription is to provide for forfeiture of the compact disk, medium, license, or otherwise from which the ringtone originated. The forfeiture may be automatic, in the event that the user can not be contacted, or in the event that the user does not renew or agree to pay for the shipping and handling of the medium or otherwise. In this manner, the compact disk, medium or license may become property of the service provider 34 and the agreement with the user will be terminated.

Referring to FIG. 12, the service provider 34 may sign up its own artists and content creators and act in the capacity of a record label itself or creative agent. In this manner, the service provider 34 may be the owner of all of the copyright rights in the music or content, to the extent possible under current Copyright Laws of the particular jurisdiction. The service provider's artists or creators may likewise include artists or creators where the service provider 34 is alleviated from having to pay the normal royalties owed the copyright owners if the music or corresponding ringtone was provided in a typical manner. In general, the artists or creators provided by the service provider 34 will incur less royalties than would have normally otherwise because of contractual relationships with the artists or other copyright holders. The service provider 34 may provide the option to users of sampling content originating with its own artists or creators at block 350. The user may select one of the service provider 34 artists or creators at block 352. The user may, after downloading (e.g., purchasing) ringtone on non-service provider artist compact disks, media, or licenses at block 360, select to exchange the currently downloaded ringtone for a ringtone originating with one of the service provider artists or creators at block 350 before signing off the service. In this manner, the time between uses of the system by the user during which the user may be “parked” on expensive compact disks or other expensive audio files is minimized. This may reduce the expense of the available audio files for the service provider 34. This frees up additional audio files for other users and reduces the inventory required by the service provider 34 to provide a full selection of ringtones.

The preferred embodiments envision that ringtones may be transferred by some type of file transfer. In addition, the ringtones may be free from encryption that limits their use, copyright water marking, proprietary formats for a particular system, a file encryption that inhibits copying of the file, a file encryption that inhibits or otherwise limits the number of copies that may be made, time limited durations, etc. In this manner, the ringtones are freely transferable from one cell phone to another, while operating properly. In addition, the ringtone may be provided to the user in a manner that requires modification of the audio file after downloading prior to activating the ringtone. In this manner, the distribution of the ringtones may be more readily controlled, if desired. If desired, the ringtones may be directly provided via e-mail, Wireless Access Protocol (WAP) or through connection to the Internet or likewise to the user or otherwise made available for downloading from the server. The server may make the ringtones available in an “in box” or other user account that resides on the server. In this manner, the ringtones are made available and the user may selectively download the desired ringtones. After the ringtones are exchanged, transferred, sold, or ownership is otherwise relinquished or transferred, the server may simply remove access to the audio files from the user's “in box” or the user's account.

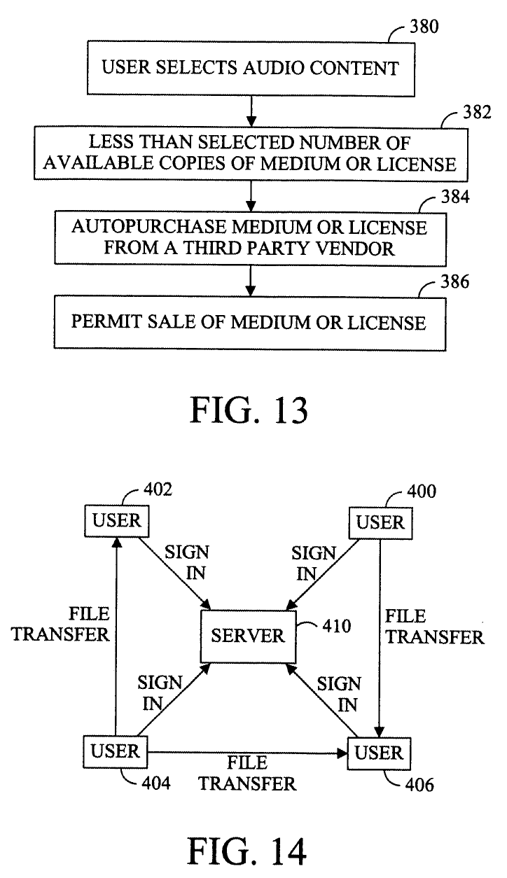

Referring to FIG. 13, the user may select audio content for a ringtone at block 380. If the system determines that less than a selected number of copies of the corresponding compact disk, medium or license are available, such as zero, one, two, etc., then the system at block 382 may desire to obtain additional copies or otherwise obtaining rights to additional audio files. While ordering additional media or digital rights through the mail is possible, it is prohibitively time consuming when a customer desires immediate access to the ringtones. To overcome this limitation, a computer networked based automatic purchasing agent may be used to purchase additional compact disks, media, licenses, or other rights at block 384. In the event that there were no additional copies or other rights available from the server (or less than the desired number), the ringtones are permitted to be downloaded or otherwise purchased at block 386 after the automated purchasing agent has secured the rights to additional copies of the media or instances of ownership rights.

The system may track the exchange of audio files for particular users. In this manner valuable statistical data is obtained that may be used for any suitable purpose, including the selection of additional ringtones. The data may include, for example, popularity of particular ringtones, popularity of ringtones corresponding to particular songs on particular media, popularity of ringtones or media as a function of the time of day, popularity of ringtones as a function of the region of the country, popularity of ringtones as a function of the age of the user, popularity of ringtones as a function of the sex of the user, popularity of ringtones as a function of the demographics of the user, popularity of ringtones as a function of the income of the user, popularity of ringtones as a function of the duration of use by the user, popularity of ringtones as a function of the artist or creator, popularity of ringtones as a function of the genre of the corresponding audio files, popularity of ringtones as a function of the year, and popularity of ringtones as a function of the decade/year the corresponding audio file was released.

Referring to FIG. 14, in another embodiment the system may be used in a peer-to-peer environment where different users 400, 402, 404, and 406 sign into the server 410. The users preferably provide a list of available ringtones to the server 410 or to all, or a selected set of, the other users which can be exchanged with other users. The users may then search the server to locate other users that have desirable ringtones or other audio files available for reformatting and downloading from the other user. In this manner the server 410 acts as a clearing house for transfer of available ringtones between users. In addition, the server 410 likewise preferably tracks which ringtones each of the users has ownership rights in. In addition, the sever 410 may be implemented in the manner of a distributed server residing on one or more of the user's computers. When a user desires to obtain ownership rights to another ringtone, the server 410 or otherwise distributed server “locks” out a corresponding compact disk, medium, license or otherwise makes available audio ownership rights for the user receiving a copy of the ringtone from the other user. In this manner, the server 410 acts as an ownership clearing house for the audio ownership rights. In a similar manner, users may transfer ownership rights to a ringtone back to the server 410, or others users, and obtain new ringtones from other users, while the server 410 or other user provides the user downloading the ringtone with the proper ownership rights, including ownership to the corresponding media. In this manner, the server 410 (or other users) acts as a clearing house for ringtones while the ringtones are being transferred between users, as opposed to a transfer from the server itself.

The system shown in FIG. 14 may be extended to eliminate the server, where the users perform the exchange between themselves. In this manner, the users will transfer the ringtones between themselves while likewise providing the compact disk, medium or license to the other user. Alternatively, the user may store the compact disk or other medium on behalf of the user obtaining the ringtone. Further, the user providing the ringtone preferably deletes any copies of the ringtone that the provider has after the transfer.

In addition to ringtones, the system may be used to transfer digital files that may include other audio content, video content, computer software, or any other type of digital content.

The detailed description, above, sets forth numerous specific details to provide a thorough understanding of the present invention. However, those skilled in the art will appreciate that the present invention may be practiced without these specific details. In other instances, well known methods, procedures, components, and circuitry have not been described in detail to avoid obscuring the present invention.

All the references cited herein are incorporated by reference.

The terms and expressions that have been employed in the foregoing specification are used as terms of description and not of limitation, and there is no intention, in the use of such terms and expressions, of excluding equivalents of the features shown and described or portions thereof, it being recognized that the scope of the invention is defined and limited only by the claims that follow.

The invention claimed is:

1. A method for providing a ringtone for a mobile telephone, said method comprising the steps of:
(a) storing an audio file on a server arranged to communicate with said mobile telephone;
(b) selecting a ringtone for purchase, said ringtone corresponding to at least a portion of said audio file;
(c) determining an availability for sale of a copy of said audio file;
(d) if a copy of said audio file is available for sale, transferring an instance of said ringtone to said mobile telephone; and
(e) preventing a transfer of another instance of said ringtone unless a right to sell another copy of said audio file has been acquired.

2. The method for providing a ringtone for a mobile telephone of claim 1 wherein the step of determining an availability for sale of a copy of said audio file comprises the steps of:
(a) acquiring a right transfer a copy of said audio file;
(b) transferring ownership of said right to a purchaser of said ringtone; and
(c) determining that at least one instance of said right remains available to be transferred.

3. The method for providing a ringtone for a mobile telephone of claim 2 wherein the step of acquiring a right transfer a copy of said audio file comprises the step of acquiring a medium including content comprising said audio file.

4. The method for providing a ringtone for a mobile telephone of claim 2 wherein the step of acquiring a right transfer a copy of said audio file comprises the step of acquiring a right to transfer a paid-up license to a copy of said audio file.

5. The method for providing a ringtone for a mobile telephone of claim 2 wherein the step of acquiring a right transfer a copy of said audio file comprises the step of acquiring one of a previously transferred medium including content comprising said audio file and a right to transfer a paid-up license to a copy of said audio file from a previous ringtone purchaser.

6. The method of claim 5 further comprising the step of confirming deletion of said ringtone from a mobile telephone of said previous ringtone purchaser.

7. The method for providing a ringtone for a mobile telephone of claim 2 wherein the step of acquiring a right transfer a copy of said audio file comprises the step of confirming acquisition by a user seeking to purchase said ringtone of one of a previously transferred medium including content comprising said audio file and a right to transfer a paid-up license to a copy of said audio file from a previous ringtone purchaser.

8. The method of claim 7 further comprising the step of confirming deletion of said ringtone from a mobile telephone of said previous ringtone purchaser.

9. The method for providing a ringtone for a mobile telephone of claim 1 wherein the step of preventing transfer of another instance of said ringtone unless a right to sell another copy of said audio file has been acquired comprises the steps of:
(a) acquiring a right to transfer a copy of said audio file;
(b) transferring ownership of said right to a purchaser of said ringtone; and
(c) preventing transfer of said ringtone if at least one instance of said right has not been previously transferred.

10. The method for providing a ringtone for a mobile telephone of claim 9 wherein the step of acquiring a right transfer a copy of said audio file comprises the step of acquiring a medium including content comprising said audio file.

11. The method for providing a ringtone for a mobile telephone of claim 9 wherein the step of acquiring a right transfer a copy of said audio file comprises the step of acquiring a right to transfer a paid-up license to a copy of said audio file.

12. The method for providing a ringtone for a mobile telephone of claim 9 wherein the step of acquiring a right transfer a copy of said audio file comprises the step of acquiring one of a previously transferred medium including content comprising said audio file and a right to transfer a paid-up license to a copy of said audio file from a previous ringtone purchaser.

13. The method of claim 12 further comprising the step of confirming deletion of said ringtone from a mobile telephone of said previous ringtone purchaser.

14. The method for providing a ringtone for a mobile telephone of claim 9 wherein the step of acquiring a right transfer a copy of said audio file comprises the step of confirming acquisition by a user seeking to purchase said ringtone of one of a previously transferred medium including content comprising said audio file and a right to transfer a paid-up license to a copy of said audio file from a previous ringtone purchaser.

15. The method of claim 7 further comprising the step of confirming deletion of said ringtone from a mobile telephone of said previous ringtone purchaser.
